(19) United States
(12) Patent Application Publication
(10) Pub. No.: US 2014/0319082 A1
(43) Pub. Date: Oct. 30, 2014

(54) HIGH-IN FAST-OUT EFFICIENT PRESS FILTER AND FAST CHARGING METHOD

(71) Applicant: Songyan Zhou, Hangzhou (CN)

(72) Inventor: Songyan Zhou, Hangzhou (CN)

(21) Appl. No.: 14/369,483

(22) PCT Filed: Jan. 6, 2012
(86) PCT No.: PCT/CN2012/070086

§ 371 Date: Jun. 27, 2014

(30) Foreign Application Priority Data
Dec. 28, 2011 (CN) 201110447069.5
Dec. 28, 2011 (CN) 201110447082.0

(51) Int. Cl. B01D 25/12

(52) U.S. Cl. CPC B01D 25/12
USPC 210/806; 210/231

(57) ABSTRACT

The present invention relates to a fast-in and fast-out efficient filter press and rapid feeding method having rapid feeding and rapid discharging functions, comprising a filter press, wherein the upper ends of multiple cloth filter plates or diaphragm filter plates in a cloth filter plate group or diaphragm filter plate group in the filter press are provided with feeding ports, and the lower parts are provided with discharging ports; a vertical lifting feeding assembly is positioned above the feeding ports in the cloth filter plastic group or side of the feeding assembly are respectively and correspondingly matched with the feeding ports of the multiple cloth filter plates or diaphragm filter plates in a cloth filter plate group or diaphragm filter plate group. The fast-in and fast-out efficient filter press has the advantages that: firstly, a precedent of straight-through feeding of the cloth filter plates is created, and high feeding efficiency, smooth feeding and low energy consumption are achieved; secondly, a one-way valve is used a valve of each feeding port, so high-speed feeding requirement can be met and also the valves can be automatically closed after feeding is ended, and the squeezing requirement of the cloth filter plates is met; thirdly, the discharging ports are formed at the lower parts of the cloth filter plates, therefore the discharge speed is high and energy is not consumed.

### TECHNICAL FIELD

The present invention relates to a fast-in and fast-out efficient filter press and rapid feeding method having rapid feeding and rapid discharging functions, belonging to manufacturing field of filter plate.

### BACKGROUND ART

The patent CN101385913A that belongs to applicant of the present invention, titled as “Fillet feeding diaphragm filter plate assembly constituted by flat membrane and filter board”, comprises the flat membrane filter plate and the filter cloth filter plate. Both the flat membrane filter plate and the filter cloth filter plate are single-corner feeding through holes and are arranged in cross banding. What need to be improved are as follows: multiple filter cloth filter plates are overlaid to form the feeding channel and the material needs to pass through the feeding channel and turn an angle of almost 90 degrees to enter the press chamber formed by the filter cloth filter plate and filter plate; however, because of the resistance of the bent channel, the feeding efficiency is low and the material feeding efficiency is influenced directly.

The patent CN201664532U, titled as “Rapid vacuum anhydration diaphragm filter press”, comprises a plurality of diaphragm filter boards separated in a filter chamber. The diaphragm filter boards comprise diaphragm cavities. At both sides of the diaphragm filter boards are arranged hot boards which comprise hot board inner cavities. One side of the filter chamber is provided with a charging aperture and a liquid discharging aperture. All hot boards and all diaphragm filter boards are connected respectively via a charging channel and a liquid discharging channel. Two ends of all hot board inner cavities and diaphragm cavities are respectively provided with inlets and outlets. Between the hot boards and the diaphragm filter boards is the space filled by compressed materials after being filtered. The utility model adopts the design integrating the press filtration dewatering process and the anhydration process and, after the materials are extruded and heated twice, makes the water content of the anhydration materials less than 30% and enables the acceleration of the dewatering speed and the reduction of the dewatering time. The utility model is low in energy consumption and small in equipment occupied area. However, the disadvantage is that it cannot realize rapid feeding.

### SUMMARY OF THE INVENTION

Design target: On the basis of the background art, design a fast-in and fast-out efficient filter press and rapid feeding method having rapid feeding and rapid discharging functions.

Design proposal: In order to realize the above target, the following design proposals are implemented: 1. The design that the feeding ports in the cloth filter plates or diaphragm filter plates are in communication with the press chamber of the cloth filter plates is the first technical feature of the present invention. As a result, because the feeding ports and the feeding channel are in communication with the press chamber of the cloth filter plates or the diaphragm filter plates, there is no resistance caused by bent channel, and the materials can enter the press chamber directly; not only the speed is rapid, but also the energy consumption is low for pressurized feeding. 2. The design that the feeding valves are equipped on the feeding ports is the second technical feature of the present invention. As a result, because the feeding valves are one-way valves, which are the typical seat valves and also named check valves or non-return valves used to prevent contra-flow of the fluid material in the fluid system, the present application uses it as the feeding valve for press chamber of the cloth filter plates or diaphragm filter plates, such that it allows materials to pass through rapidly at a high pressure state, and also automatically closes after feeding is ended, so as to meet the press requirement of filter plate. It not only creates a precedent of straight-through feeding of the cloth filter plates or diaphragm filter plates, and improves the feeding efficiency greatly, but also it is simple in structure and high convenient in operation, 3. The design that the discharging port is provided at the lower end of the cloth filter plates or diaphragm filter plates is the third technical feature of the present invention. As a result, because of the gravity, the fluid coming from pressing the materials can be discharged rapidly through the discharging port naturally under the action of the gravity, which not only improves the discharging efficiency, but also reduces the energy consumption. 4. Design of vertical lifting feeding assembly is the fourth technical feature of the present invention. As a result, outlets of the multiple feeding valves in the vertical lifting feeding assembly are respectively in communication with the multiple feeding nozzles, and the inlets of the multiple feeding valves are respectively in communication with the feeding pipes at the same interval; and upper ends of the multiple cloth filter plates or diaphragm filter plates in a cloth filter plate group or diaphragm filter plate group are provided with matched feeding ports, and the lifting column in the lifting diving mechanism is connected with the feeding pipes; therefore, the lifting diving mechanism drives the multiple feeding nozzles on the feeding pipes to be abutted with the feeding ports that are provided at the upper ends of multiple cloth filter plates or diaphragm filter plates in a cloth filter plate group or diaphragm filter plate group, such that the target of rapid butt connection and injection is realized.

Technical proposal 1: A fast-in and fast-out efficient filter press, comprising a filter press, wherein the upper ends of multiple cloth filter plates or diaphragm filter plates in a cloth filter plate group or diaphragm filter plate group in the filter press are provided with feeding ports, and the lower parts are provided with discharging ports; a vertical lifting feeding assembly is positioned above the feeding ports in the cloth filter plate group or diaphragm filter plate group; and multiple feeding nozzles in communication with the lower side of the feeding assembly are respectively and correspondingly matched with the feeding ports of the multiple cloth filter plates or diaphragm filter plates in a cloth filter plate group or diaphragm filter plate group.

Technical proposal 2: A rapid feeding method of the fast-in and fast-out efficient filter press comprising a filter press, wherein the upper ends of multiple cloth filter plates or diaphragm filter plates in a cloth filter plate group or diaphragm filter plate group in the filter press are provided with feeding ports, and the lower parts are provided with discharging ports; a vertical lifting feeding assembly is positioned above the feeding ports in the cloth filter plate group or diaphragm filter plate group; and multiple feeding nozzles in communication with the lower side of the feeding assembly are respectively and correspondingly matched with the feeding ports of the multiple cloth filter plates or diaphragm filter plates in a cloth filter plate group or diaphragm filter plate group; when the charging chamber formed between the cloth filter plates and cloth filter plates, or diaphragm filter plates and diaphragm filter plates, or cloth filter plates and diaphragm filter plates in the cloth filter plate group or diaphragm filter plate group needs to be fed, the controller sends command to descend the lifting driving mechanism in the vertical lifting feeding assembly, and the lifting driving mechanism drives the multiple feeding nozzles in the feeding pipes to be butted and in communication with the feeding ports of the multiple cloth filter plates or diaphragm filter plates in a cloth filter plate group or diaphragm filter plate group; then the controller sends command to start the electromagnetic valve that is connected with the feeding nozzles and feeding pipes, so the high-pressure fluid materials in the feeding pipes can be fed through the electromagnetic valve and feeding nozzle into the charging chamber formed between the cloth filter plates and cloth filter plates, or diaphragm filter plates and diaphragm filter plates, or cloth filter plates and diaphragm filter plates in the cloth filter plate group or diaphragm filter plate group; after feeding is ended, the controller sends command to turn off the electromagnetic valve, and the lifting driving mechanism drives to lift the feeding pipes so that the feeding nozzle is separated with the feeding port in the cloth filter plate group; then the controller sends command to the diaphragm filter press for diaphragm press, and the liquid is discharged through the discharging port rapidly.

Compared with the background art, the present invention has the following beneficial effects: firstly, a precedent of straight-through feeding of the cloth filter plates is created, and high feeding efficiency, smooth feeding and low energy consumption are achieved; secondly, a one-way valve is used a valve of each feeding port, so high-speed feeding requirement can be met and also the valves can be automatically closed after feeding is ended is ended, and the squeezing requirement of the cloth filter plates is met; thirdly, the discharging ports are formed at the lower parts of the cloth filter plates, therefore the discharge speed is high and energy is not consumed.

### BRIEF DESCRIPTION OF THE DRAWINGS

FIG. 1 is the structure diagram of the fast-in and fast-out efficient filter press before feeding.

FIG. 2 is the structure diagram of the fast-in and fast-out efficient filter press during feeding.

FIG. 3 is the local structure diagram of the lifting feeding assembly.

FIG. 4 is the structure diagram of cloth filter plate.

FIG. 5 is lateral structure diagram of the FIG. 4.

FIG. 6 is the structure diagram of the multiple overlaid fast-in and fast-out efficient cloth filter plate.

FIG. 7 is the lateral structure diagram of the diaphragm filter plate.

FIG. 8 is the structure diagram of the multiple overlaid fast-in and fast-out efficient diaphragm filter plate.

### DETAILED DESCRIPTION OF THE PREFERRED EMBODIMENTS

### Embodiment 1

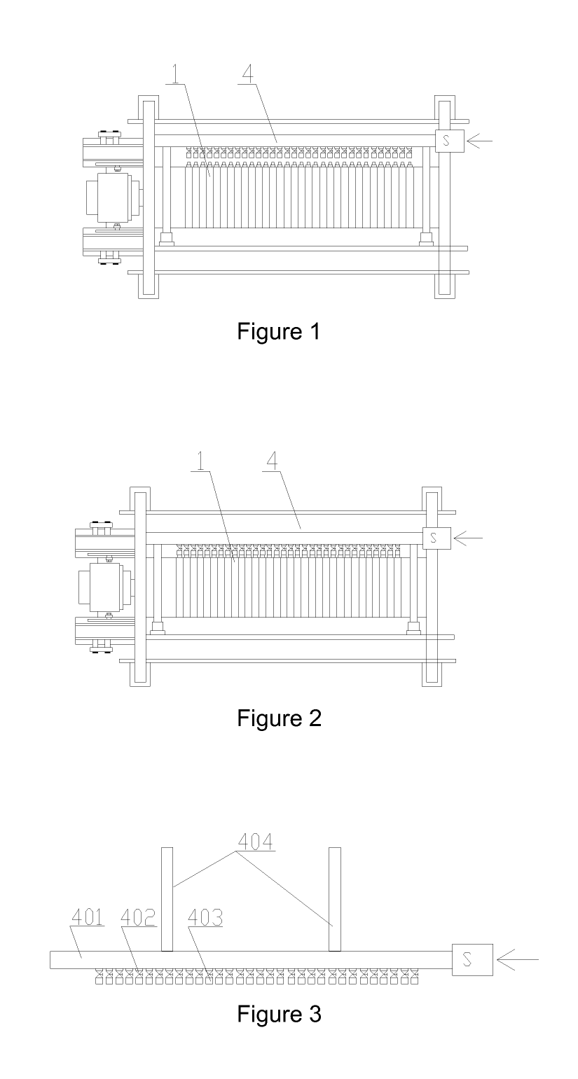

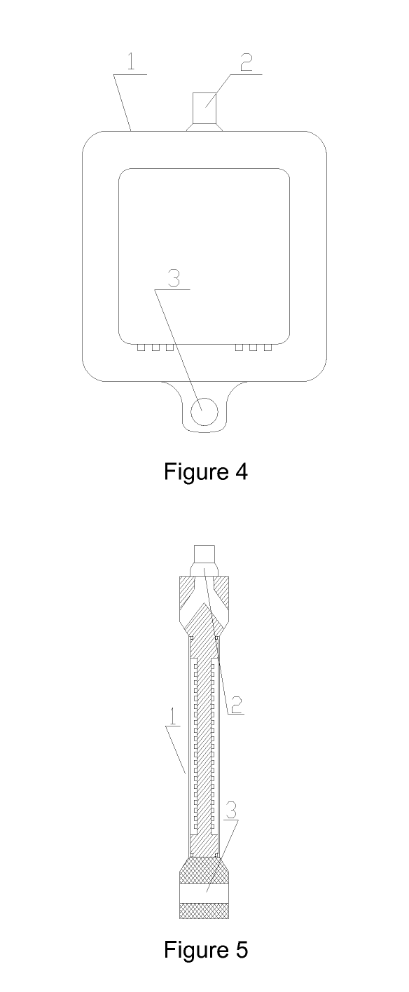

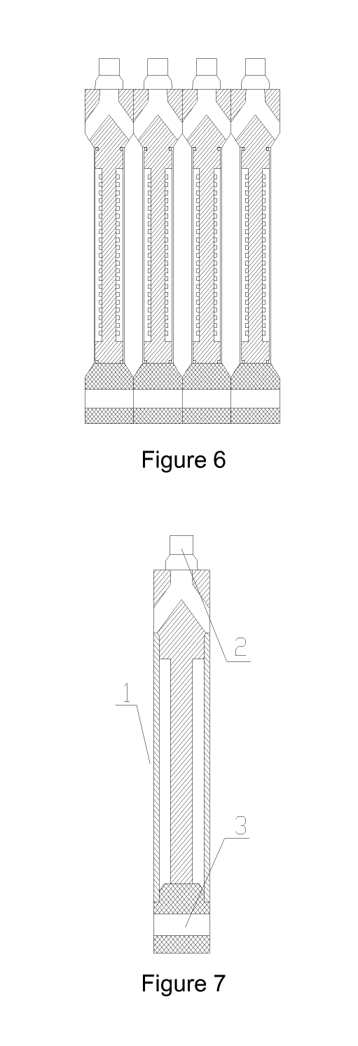

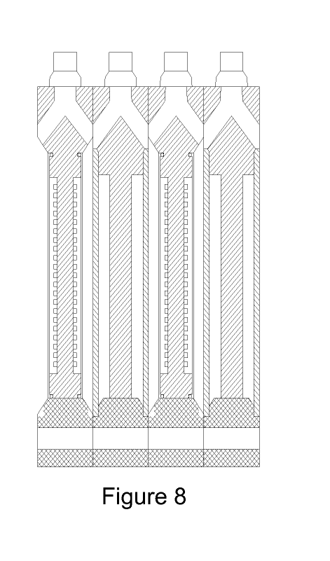

Refer to FIGS. 1-8. A fast-in and fast-out efficient filter press, comprising a filter press, wherein the upper ends of multiple cloth filter plates or diaphragm filter plates in a cloth filter plate group 1 or diaphragm filter plate group 101 in the filter press are provided with feeding ports 2, and the lower parts are provided with discharging ports 3; a vertical lifting feeding assembly 4 is positioned above the feeding ports 2 of the cloth filter plate group 1 or diaphragm filter plate group 101; and multiple feeding nozzles 403 in communication with the lower side of the feeding assembly 4 are respectively and correspondingly matched with the feeding ports 2 of the multiple cloth filter plates or diaphragm filter plates in a cloth filter plate group 1 or diaphragm filter plate group 101. The feeding ports 2 in the cloth filter plate group 1 or diaphragm filter plate group 101 are in communication with the press chamber of the cloth filter plates or diaphragm filter plates, and the feeding valves are equipped on the feeding ports 2. The feeding valves are one-way valves or electromagnetic feeding valves. The vertical lifting feeding assembly 4 is comprised of a feeding pipes 401, multiple electromagnetic valves 402, multiple feeding nozzles 403 and a lifting driving mechanism 404; outlets of the multiple feeding valves 402 are respectively in communication with the multiple feeding nozzles 403, and the inlets of the multiple feeding valves 402 are respectively in communication with the feeding pipes 401 at the same interval; the lifting column in the lifting driving mechanism 404 is connected with the feeding pipes 401. The driving signal end of the vertical lifting driving mechanism 404 is connected with signal end of the controller 5, and signal ends of the multiple feeding valves 402 are connected with the signal end of the controller 5. The vertical lifting driving mechanism 404 is a hydraulic lifting mechanism, or a spiral servo lifting mechanism, or a worm and worm wheel lifting mechanism.

### Embodiment 2

On the basis of Embodiment 1, the one-way valve is comprised of pipe connector and tapered rubber cover, wherein the upper part of the pipe connector is a feeding butt joint and locates outside of the filter plate, and the lower part is covered with highly flexible tapered rubber cover and locates inside the filter plate; the head of tapered rubber cover is stretched under pressure of the high-pressure fluid material, and it will recover after feeding is ended, namely close, to prevent contra-flow of the material.

### Embodiment 3

On the basis of Embodiments 1 and 2, a rapid feeding method of the fast-in and fast-out efficient filter press comprising a filter press, wherein the upper ends of multiple cloth filter plates or diaphragm filter plates in a cloth filter plate group 1 or diaphragm filter plate group 101 in the filter press are provided with feeding ports 2, and the lower parts are provided with discharging ports 3; a vertical lifting feeding assembly 4 is positioned above the feeding ports 2 of the cloth filter plate group 1 or diaphragm filter plate group 101; and multiple feeding nozzles 403 in communication with the lower side of the feeding assembly 4 are respectively and correspondingly matched with the feeding ports 2 of the multiple cloth filter plates or diaphragm filter plates in a cloth filter plate group 1 or diaphragm filter plate group 101; when the charging chamber formed between the cloth filter plates and cloth filter plates, or diaphragm filter plates and diaphragm filter plates, or cloth filter plates and diaphragm filter plates in the cloth filter plate group 1 or diaphragm filter plate group 101 needs to be fed, the controller 5 sends command to descend the lifting driving mechanism 404 in the vertical lifting feeding assembly 4, and the lifting driving mechanism 404 drives the multiple feeding nozzles 403 in the feeding pipes to be butted and in communication with the feeding ports 2 of the multiple cloth filter plates or diaphragm filter plates in a cloth filter plate group 1 or diaphragm filter plate group 101; then the controller 5 sends command to start the electromagnetic valve 402 that is connected with the feeding nozzles 403 and feeding pipe 401, so the high-pressure fluid materials in the feeding pipes 401 can be fed through the electromagnetic valve 402 and feeding nozzle 403 into the charging chamber formed between the cloth filter plates and cloth filter plates, or diaphragm filter plates and diaphragm filter plates, or cloth filter plates and diaphragm filter plates in the cloth filter plate group or diaphragm filter plate group; after feeding is ended, the controller 5 sends command to turn off the electromagnetic valve 402, and the lifting driving mechanism drives to lift the feeding pipes 1 so that the feeding nozzle 403 is separated with the feeding port 2 in the cloth filter plate group 1; then the controller 5 sends command to the diaphragm filter press for diaphragm press, and the liquid is discharged through the discharging port 3 rapidly. The high-pressure material is pressurized by a high-pressure pump at first, and then fed into the charging chamber formed between the cloth filter plates and cloth filter plates, or diaphragm filter plates and diaphragm filter plates, or cloth filter plates and diaphragm filter plates in the cloth filter plate group or diaphragm filter plate group. The feeding ports 2 in the cloth filter plates or diaphragm filter plates are in communication with press chamber of the cloth filter plate and are provided with feeding valves. The feeding valves are one-way valves or electromagnetic feeding valves.

What to be understood is that although the above embodiments provide detailed description to the design thought of the present invention, the text description is only simple context description to the design thought of the present invention, but not the restriction of the design thought of the present invention. Any combinations, additions or modifications to the present invention within the scope of design thought of the present invention are in the protection scope of the present invention.

1. A fast-in and fast-out efficient filter press, comprising a filter press, wherein the upper ends of multiple cloth filter plates or diaphragm filter plates in a cloth filter plate group or diaphragm filter plate group in the filter press are provided with feeding ports, and the lower parts are provided with discharging ports; a vertical lifting feeding assembly is positioned above the feeding ports in the cloth filter plate group or diaphragm filter plate group and multiple feeding nozzles in communication with the lower side of the feeding assembly are respectively and correspondingly matched with the feeding ports of the multiple cloth filter plates or diaphragm filter plates in a cloth filter plate group or diaphragm filter plate group; the vertical lifting feeding assembly is comprised of feeding pipes, multiple electromagnetic valves, multiple feeding nozzles and a lifting driving mechanism; outlets of the multiple feeding valves are respectively in communication with the multiple feeding nozzles, and the inlets of the multiple feeding valves are respectively in communication with the multiple discharging nozzles at the same interval; the lifting column in the lifting driving mechanism is connected with the feeding pipes.

2. The fast-in and fast-out efficient filter press according to claim 1, wherein the feeding ports in the cloth filter plate group or diaphragm filter plate group are in communication with the press chamber of the cloth filter plates or diaphragm filter plates, and the feeding valves are equipped on the feeding ports.

3. The fast-in and fast-out efficient filter press according to claim 2, wherein the feeding valves are one-way valves or electromagnetic feeding valves.

4. The fast-in and fast-out efficient filter press according to claim 1, wherein the driving signal end of the vertical lifting diving mechanism is connected with the signal end of the controller, and signal ends of the multiple feeding valves are connected with the signal end of the controller.

5. The fast-in and fast-out efficient filter press according to claim 1, wherein the vertical lifting driving mechanism is a hydraulic lifting mechanism, or a spiral servo lifting mechanism, or a worm and worm wheel lifting mechanism.

6. A rapid feeding method of the fast-in and fast-out efficient filter press comprising a filter press, wherein the upper ends of multiple cloth filter plates or diaphragm filter plates in a cloth filter plate group or diaphragm filter plate group in the filter press are provided with feeding ports, and the lower parts are provided with discharging ports; a vertical lifting feeding assembly is positioned above the feeding ports in the cloth filter plate group or diaphragm filter plate group; and multiple feeding nozzles in communication with the lower side of the feeding assembly are respectively and correspondingly matched with the feeding ports of fee multiple cloth filter plates or diaphragm filter plates in a cloth filter plate group or diaphragm filter plate group; when the charging chamber formed between the cloth filter plates and cloth filter plates, or diaphragm filter plates and diaphragm filter plates, or cloth filter plates and diaphragm filter plates in the cloth filter plate group or diaphragm filter plate group needs to be fed, the controller sends command to descend the lifting driving mechanism in the vertical lifting feeding assembly, and the lifting driving mechanism drives the multiple feeding nozzles in the feeding pipes to the butted and in communication with the feeding ports of the multiple cloth filter plates or diaphragm filter plates in a cloth filter plate group or diaphragm filter plate group; then the controller sends command to start the electromagnetic valve that is connected with the feeding nozzles and the feeding pipes, so the high pressure fluid material in the feeding pipes can be fed through the electromagnetic valve and feeding nozzle into the charging chamber formed between the cloth filter plates and cloth filter plates, or diaphragm filter plates and diaphragm filter plates, or cloth filter plates and diaphragm filter plates in the cloth filter plate group or diaphragm filter plate group; after feeding is ended, the controller sends command to turn off the electromagnetic valve, and the lifting driving mechanism drives to lift the feeding pipes so that the feeding nozzle is separated with the feeding port in the cloth filter plate group; then the controller sends command to the diaphragm filter press for diaphragm press, and the liquid is discharged through the discharging port rapidly.

7. The rapid feeding method of the last-in and fast-out efficient filter press according to claim 6, wherein the high-pressure material is pressurized by a high-pressure pump at first, and then ted into the charging chamber formed between the cloth filter plates and cloth filter plates, or diaphragm filter plates and diaphragm filter plates, or cloth filter plates and diaphragm filter plates in the cloth filter plate group or diaphragm filter plate group.

8. The rapid feeding method of the fast-in and fast-out efficient filter press according to claim 6, wherein the feeding ports in the cloth filter plates or diaphragm filter plates are in communication with press chamber of the cloth filter plate and are provided with feeding valves.

9. The rapid feeding method of the fast-in and fast-out efficient filter press according to claim 8, wherein the feeding valves are one-way valves, or electromagnetic feeding valves.

10. The fast-in and fast-out efficient filter press according to claim 4, wherein the vertical lifting driving mechanism is a hydraulic lifting mechanism, or spiral servo lifting mechanism, or a worm and worm wheel lifting mechanism.
